(19) United States
(12) Patent Application Publication
(10) Pub. No.: US 2002/0086786 A1
(43) Pub. Date: Jul. 4, 2002

(54) Sheet folding apparatus and image forming apparatus having the same

(76) Inventors: Mitsugu Kamizuru, Shizuoka (JP); Yoshifumi Takehara, Chiba (JP); Yuji Yamanaka, Ibaraki (JP)

Correspondence Address: FITZPATRICK CELLA HARPER & SCINTO, 30 ROCKEFELLER PLAZA, NEW YORK, NY, 10112, US

(21) Appl. No.: 10/021,088

(22) Filed: Dec. 19, 2001

(30) Foreign Application Priority Data
Dec. 28, 2000 (JP) 400377/2000

(51) Int. Cl. B31F 1/00

(52) U.S. Cl. 493/405

(57) ABSTRACT

In a sheet folding apparatus for nipping and conveying a sheet by a pair of folding rollers and folding the sheet, at least one roller of the pair of folding rollers has large- and small-diameter portions along the axis. The contact area between the sheet and each folding roller can be reduced. As a result, a relief for the pressure from the two ends of the roller shaft in folding a sheet can be ensured at a portion where the sheet creases, and any crease can be prevented.

### BACKGROUND OF THE INVENTION

1. Field of the Invention

The present invention relates to a sheet folding apparatus for folding a sheet and an image forming apparatus having the same.

2. Description of the Related Art

A conventional sheet folding apparatus of this type folds a sheet such as paper in half or three.

“Half-folding” means folding in two at the central position of a sheet as a fold in the longitudinal convey direction.

In folding in three (“Z-folding”), a sheet is folded once at a ¼ position as a fold from one sheet end in the longitudinal convey direction, and then folded at a ¼ position from the other end of the sheet in the opposite direction. Since ¼ positions from the tip ends of a sheet are set as folds in first and second operations of folding in three, the folded sheet is half in size the original sheet.

This sheet folding apparatus is used in combination with a copying machine, laser beam printer, or the like. A sheet on which an image is formed on its surface by a copying machine or the like is folded in half or three with the image surface facing inward. This structure is efficient because folding ends at almost the same time as the end of image formation without any time for folding after image formation.

However, the conventional technique suffers the following problems.

In the conventional sheet folding apparatus, a sheet creases in sheet folding processing.

FIG. 7A shows the structure of a conventional folding processing portion. Conventionally, to prevent a crease, the roller uses CR (neoprene) rubber with a hardness of 70° to 90°. Further, the central diameters of rollers 56 and 64 are set smaller than the diameters of their ends, and a downward gradient of about 0.112° is formed from the two ends to center of each of the rollers 56 and 64. Then, a sheet is conveyed while being pulled in the widthwise direction at the two ends of each of the rollers 56 and 64 (see FIG. 7A).

Also in this case, however, a sheet P contacts the rollers 56 and 64 across the whole area. When the sheet P is nipped and conveyed while its tip end and looped folded portion are simultaneously pulled in the widthwise direction at the two ends of each of the rollers 56 and 64, the pressure from the two ends of each of the rollers 56 and 64 toward the center with respect to the folding pressure in sheet folding cannot be relieved, generating a crease at a position as shown in FIG. 7A.

If the tip end or looped folded portion of the sheet P is nipped diagonally with respect to the roller nip line due to skew feeding or the like, or the roller nip line itself is diagonal owing to variations in nip pressure in the widthwise direction of the rollers 56 and 64, the sheet P is nipped and conveyed diagonally with respect to the nip line, readily causing a crease. The crease cannot be completely prevented.

The folding pressure of a pair of rollers may be so decreased as not to generate any crease. For a low folding pressure, the fold becomes loose, and the folded sheet becomes bulky. Such a sheet is unstably stacked on a sheet tray, so the number of sheets stackable on the sheet tray is limited.

As another measure, the friction coefficient of each of a pair of folding rollers may be decreased by, e.g., applying silicone oil to the roller surface. A sheet is pressed between the rollers into tight contact with the rollers entirely in the widthwise direction, and inserted under pressure into the nip portions. This can prevent generation of any wrinkle. Also in this case, however, the friction coefficient including the durability of each roller is difficult to maintain at a constant value.

### SUMMARY OF THE INVENTION

The present invention has been made to overcome the conventional drawbacks, and has as its object to provide a sheet folding apparatus with a stable, high-precision sheet folding processing technique that can prevent the crease without any unstable sheet stacking or convey error, and an image forming apparatus having the same.

To achieve the above object, according to the present invention, there is provided a sheet folding apparatus having a sheet folding processing section for nipping and conveying a sheet by a pair of folding rollers and folding the sheet, wherein at least one of the pair of folding rollers has large- and small-diameter portions along an axis thereof.

In this arrangement, the sheet and each folding roller come into contact with each other at the large-diameter portion when the sheet is nipped at the nip portion between the pair of folding rollers. As a result, the contact area between the sheet and each folding roller can be reduced. A relief for the pressure from the two ends of the roller shaft in folding a sheet can be ensured at a portion where the sheet creases, and any crease can be prevented.

A large-diameter portion for nipping and conveying the sheet is formed at a sheet convey center portion of the roller.

The portion where the roller comes into contact with the sheet is concretely set at the sheet convey center portion of the roller. The contact area in conveying and nipping the sheet at the large-diameter portion is decreased, a relief is secured for the sheet folding pressure, and any crease is prevented.

The large-diameter portion is desirably formed at the sheet convey center portion such that a width of the large-diameter portion along the axis that is formed at the sheet convey center portion of the folding roller is almost ½ a minimum width of a sheet size foldable in the sheet folding apparatus.

The width of the large-diameter portion is set almost half the minimum width of the sheet size foldable in the sheet folding apparatus. This enables stable folding processing at the sheet convey center portion. The fold does not become loose, the folded sheet does not become bulky on the sheet tray, and the sheet can be stably stacked.

The large-diameter portion of the roller is positioned outside a movable range of a maximum-size sheet in the apparatus.

The large-diameter portion outside the maximum convey size of the sheet is set such that the sheet does not contact the large-diameter portion. This can prevent any crease of the sheet caused by inclined feeding or skew feeding of the sheet at the large-diameter portion.

A predetermined gap is desirably formed between the rollers at a convey nip between the pair of folding rollers.

The predetermined gap between the rollers is effectively set smaller than a thickness of three sheets conveyed to the nip.

The gap between the rollers can ensure a relief for the sheet with respect to the sheet folding pressure when the convey nip portion tightly nips the sheet. The gap is effective for preventing any crease.

In the sheet folding apparatus, the large-diameter portion of the roller may have a taper.

By tapering the ends of large-diameter portions at the two ends and center of the folding roller, the ends can more gently contact the sheet. The crease can therefore be reduced when the sheet is folded at the nip portion.

An image forming apparatus having image forming means for forming an image on a sheet, sheet conveying means for conveying the sheet on which the image is formed by the image forming means, and sheet folding processing means for folding the conveyed sheet comprises the above-described sheet folding apparatus as the sheet folding processing means.

The image forming means may be of the ink-jet type, thermal transfer recording type, or thermal recording type other than the electrophotographic type.

The sheet folding apparatus of the present invention has small- and large-diameter portions along the axis of each roller of a pair of folding rollers, and nips and conveys a sheet at the large-diameter portion. In folding the sheet, the contact area of the sheet on the roller can be decreased to prevent any crease.

The width at the sheet convey center portion in the region with a large roller diameter is set almost half the minimum width of a sheet size foldable in the sheet folding processing section. The sheet can be tightly folded at the sheet convey center portion without loosening it. The folded sheet does not become bulky and can be stably stacked on the sheet tray.

The large-diameter portion outside the maximum convey size of the sheet is formed at a position where the sheet does not contact the large-diameter portion in consideration of the lateral registration shift of the sheet.

This setting can prevent any crease or convey error caused by nipping the sheet at the convey nip of the roller when a lateral registration shift or the like occurs.

Hence, the sheet folding apparatus can realize stable, high-precision sheet folding processing.

The image forming apparatus comprises the sheet folding apparatus in the sheet folding processing section. The present invention can provide an image forming apparatus for performing stable, high-precision sheet folding processing without any unstable sheet stacking or convey error.

### BRIEF DESCRIPTION OF THE DRAWINGS

FIG. 1 is a schematic front sectional view showing a copying machine as an example of an image forming apparatus according to an embodiment of the present invention;

FIG. 2 is a control block diagram showing the copying machine as an example of the image forming apparatus according to the embodiment of the present invention;

FIG. 3 is a schematic front view showing a folding processing section and finisher;

FIGS. 4A and 4B are schematic front sectional views for explaining the operation of a section for processing of folding in three, in which FIG. 4A is a view showing a state immediately before a sheet is folded in two, and FIG. 4B is a view showing a state wherein the sheet is folded in two;

FIGS. 5A, 5B and 5C are schematic front sectional views for explaining the operation of the section for processing of folding in three or Z shape, in which FIG. 5A is a view showing a state immediately before a sheet is folded in three, FIG. 5B is a view showing a state wherein folding of the sheet in three starts, and FIG. 5C is a view showing a state wherein the sheet is folded in three and discharged;

FIG. 6 is a perspective view showing the roller of the section for processing of folding in three according to the embodiment;

FIGS. 7A, 7B and 7C are schematic front sectional views for explaining the operation of the section for processing of folding in three, in which FIG. 7A is a view showing a conventional section for processing of folding in three, FIG. 7B is a view showing the section for processing of folding in three according to the embodiment of the present invention and a state wherein the large-diameter portion of the section for processing of folding in three contacts a sheet P, and FIG. 7C is a view showing another section for processing of folding in three and a state wherein the large-diameter portion of the section for processing of folding in three contacts the sheet P; and

FIG. 8 is a control block diagram showing the section for processing of folding in three.

### DETAILED DESCRIPTION OF THE PREFERRED EMBODIMENTS

A preferred embodiment of the present invention will be described in detail below with reference to the accompanying drawings. The size, material, shape, relative layout, and the like of building components described in the embodiment do not limit the spirit and scope of the present invention, unless otherwise specified.

In the following drawings, the same reference numerals denote the same parts as those shown in the drawings used in “Description of the Related Art” and the above-mentioned drawings.

The embodiment of the present invention will be explained below with reference to the drawings.

### Copying Machine 1000

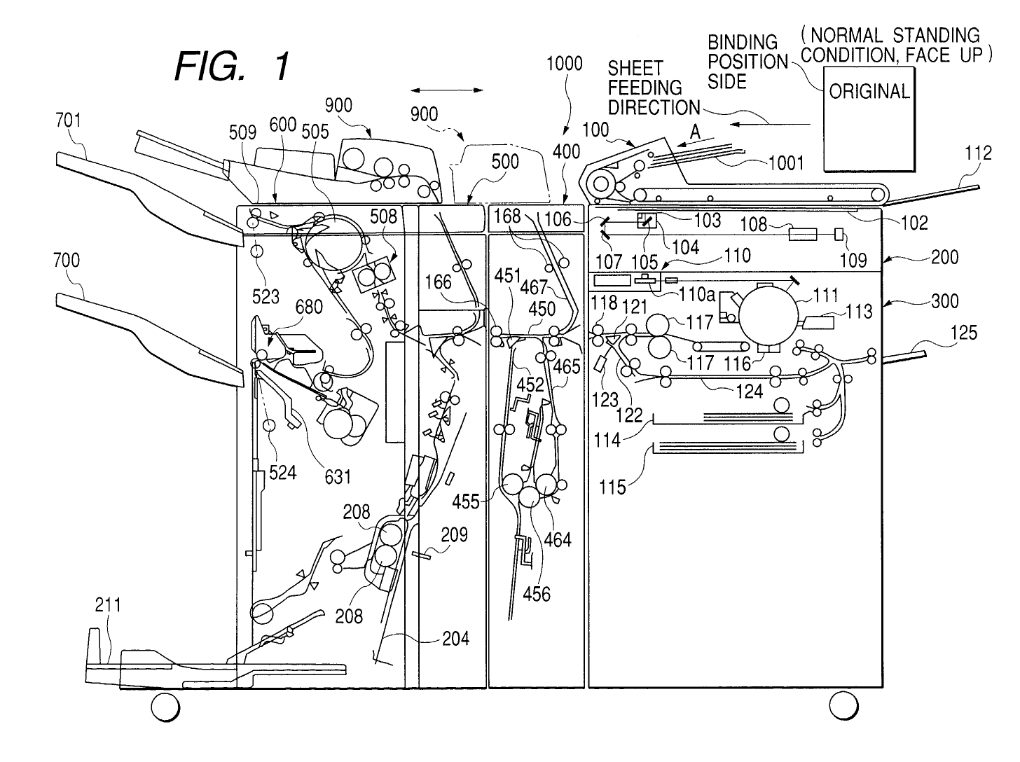

FIG. 1 is a schematic front sectional view showing the internal structure of a copying machine 1000 according to the embodiment of the present invention. The copying machine 1000 comprises an original feeding section 100, an image reader section 200, an image forming unit 300, a section 400 for processing of folding a sheet in three, a folding processing section 500 for folding a sheet in two, a finisher 600, and an inserter 900.

The sheet includes plain paper, a thin resin sheet postcard as a substitute of plain paper, a carton, a letter, and a thin plastic plate.

### Control System

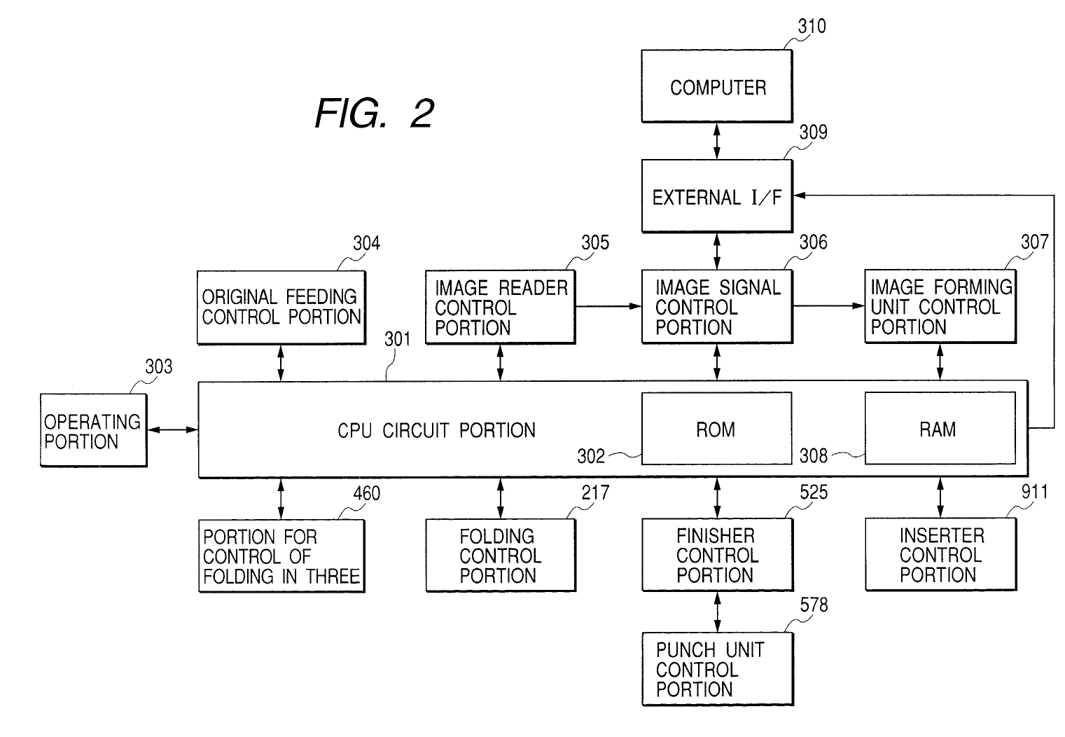

FIG. 2 is a block diagram showing the copying machine 1000. A CPU circuit portion 301 has a CPU (not shown), and controls an original feeding control portion 304, image reader control portion 305, image signal control portion 306, image forming unit control portion 307, portion 460 for control of folding in three, folding control portion 217, finisher control portion 525, inserter control portion 911, and the like in accordance with control programs stored in a ROM 302 and settings of an operating portion 303.

The original feeding control portion 304 controls the original feeding section 100; the image reader control portion 305 controls the image reader section 200; the image forming unit control portion 307 controls the image forming unit 300; the portion 460 controls the section 400; the folding control portion 217 controls the folding processing section 500; the finisher control portion 525 controls the finisher 600; and the inserter control portion 911 controls the inserter 900.

The operating portion 303 has a plurality of keys for setting various functions concerning image formation, and a display portion (not shown) for displaying the setting state. The operating portion 303 outputs a key signal corresponding to the user operation of each key to the CPU circuit portion 301. In addition, the operating portion 303 displays information corresponding to a signal from the CPU circuit portion 301 on the display portion.

A RAM 308 is used as an area for temporarily holding control data and an arithmetic work area along with control. An external interface (I/F) 309 interfaces between the copying machine 1000 and the computer 310. The external interface 309 maps print data from a computer 310 into a bitmap image, and outputs the image as image data to the image signal control portion 306.

The image reader control portion 305 outputs an original image read by an image sensor 109 to the image signal control portion 306.

The image forming unit control portion 307 outputs image data from the image signal control portion 306 to an exposure control portion 110.

### Original Feeding Section 100 & Image Reader Section 200

Assume that an original is set on a tray 1001 of the original feeding section 100 shown in FIG. 1 in a normal standing condition with a face-up state (with an image-bearing surface facing up) when viewed from the user. The binding position of the original is at the left end of the original.

Original pages set on the tray 1001 are conveyed one by one from the top page by the original feeding section 100 in the left direction (direction indicated by an arrow A in FIG. 1) with the binding position setting as a tip end. The original is discharged onto a platen glass 102 via a curved path 101.

At this time, a scanner unit 104 is held at a predetermined position. The original passes on the scanner unit 104 from the left to right, thereby reading the original. This reading method will be called original flow scanning.

When the original passes on the platen glass 102, it is irradiated by a lamp 103 of the scanner unit 104. Light reflected by the original is guided to the image sensor 109 via mirrors 105, 106, and 107 and a lens 108. After reading processing, the original is discharged onto an original tray 112.

The original can also be read by temporarily stopping the original conveyed by the original feeding section 100 on the platen glass 102 and moving the scanner unit 104 from the left to right in this state. This reading method will be called fixed original scanning. After reading processing, the original is discharged onto the original tray 112.

When the original is to be read without using the original feeding section 100, the user pulls up the original feeding section 100 and sets the original on the platen glass 102. In this case, fixed original reading is done.

### Image Forming Unit 300

Image data of the original read by the image sensor 109 is subjected to predetermined image processing and sent to the exposure control portion 110. The exposure control portion 110 outputs a laser beam corresponding to the image signal. The laser beam irradiates a photosensitive drum 111 while being scanned by a polygon mirror 110a. An electrostatic latent image corresponding to the scanned laser beam is formed on the photosensitive drum 111.

The electrostatic latent image formed on the photosensitive drum 111 is developed by a developing device 113 and visualized as a toner image. A sheet is conveyed from any one of cassettes 114 and 115, a manual feeding portion 125, and a double-side convey path 124 to a transferring portion 116.

The visualized toner image is transferred to the sheet by the transferring portion 116. The image-transferred sheet undergoes fixing processing at a fixing portion 117.

The sheet having passed through the fixing portion 117 is temporarily guided to a path 122 by pivoting a flapper 121 by the operation of a plunger 123. After the trailing end of the sheet passes through the flapper 121, the sheet is switched back and conveyed to a pair of discharge rollers 118 via the flapper 121. Then, the sheet is discharged from the image forming unit 300 via the pair of discharge rollers 118.

The sheet can be discharged from the image forming unit 300 with the toner-image-bearing surface facing down (face down). This will be called reversal discharge.

By discharging a sheet from the image forming unit 300 in the face-down state, sheets can be arranged in the page order when image formation processing is performed from the first page, for example, when image formation processing is performed using the original feeding section 100 or performed for image data from the computer.

To execute image formation processing for a hard sheet such as an OHP sheet conveyed from the manual feeding portion 125, the sheet is discharged from the image forming unit 300 via the pair of discharge rollers 118 with the toner-image-bearing surface facing up (face up) without guiding the sheet to the path 122.

To execute image formation processing for the two sides of a sheet, the sheet is directly guided from the fixing portion 117 to the pair of discharge rollers 118. After the trailing end of the sheet passes through the flapper 121, the sheet is switched back and conveyed to the double-side convey path via the flapper 121.

The sheet may curl while being switched back by the flapper 121 in reversal discharge. For example, the sheet may curl concavely (U shape).

In this case, a sheet discharged onto a sample tray 701 or stack tray 700 of the finisher 600 through the section 400 and folding processing section 500 deforms to a concave curl, which obstructs discharging the next sheet onto the tray.

Such a sheet jam in sheet discharge is prevented by discharging a sheet reaching a pair of rollers 509 of the sample tray 701 or a pair of rollers 680 of the stack tray 700 at a speed higher than that in non-reversal discharge.

To discharge a sheet at a speed higher than that in non-reversal discharge, a motor 523 for a pair of discharge rollers that rotates the pair of rollers 509 of the sample tray 701 or a motor 524 for a pair of discharge rollers that rotates the pair of rollers 680 of the stack tray 700 is rotated and controlled at a high speed by the finisher control portion 525 (to be described later) when the plunger 123 performs the reversal discharge operation. As a result, a sheet is quickly discharged.

Note that the sheet discharge speed when a sheet is not reversed is about 350 mm/s, and the sheet discharge speed when a sheet is reversed is about 450 mm/s.

In the copying machine described above, a sheet curls in the U shape. Even if a sheet curls in an inversed U shape (to be referred to a convex curl), the sheet jam can be similarly prevented.

There is also a copying machine in which when a sheet curls concavely or convexly due to heat and is reversed, the sheet is curled in a direction opposite to the curl, canceling the curl.

In this case, a sheet discharged without any reverse curls. The sheet jam can be prevented by increasing the sheet discharge speed in discharging the sheet without any reverse to be higher than the sheet discharge speed in reversing and discharging the sheet.

The sheet may curl when it passes through the section 400, folding processing section 500, and inserter 900 (to be described later). A sheet having passed through the finisher 600 may curl. Also in these cases, the sheet jam can be similarly prevented.

### Folding Processing Section 500

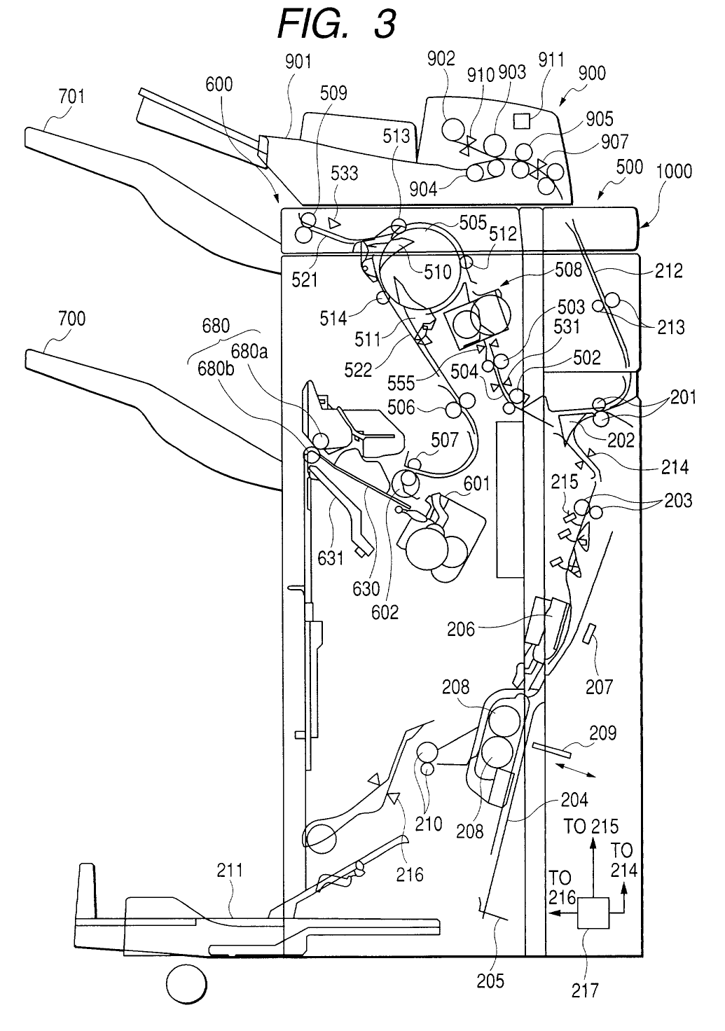

The folding processing section 500 will be described in detail with reference to FIG. 3. The folding processing section 500 binds a bundle of sheets having passed through the section 400 (see FIG. 1) or folds sheets in two without binding them on the basis of an instruction from the operating portion 303 (see FIG. 2), and discharges the sheets onto the tray 700 or 701 of the copying machine 1000.

A sheet having passed through the section 400 is conveyed by a pair of entrance rollers 201, guided to a flapper 202, and stored in a storage guide 204 via a pair of convey rollers 203. If the folding processing section 500 does not fold a sheet in two, the flapper 202 guides the sheet to the finisher 600.

A predetermined number of sheets are sequentially conveyed by the pair of convey rollers 203 until the tip of each sheet contacts a movable sheet positioning member 205, and stocked as a bundle in the sheet positioning member 205.

Two pairs of staplers 206 are arranged downstream from the pair of convey rollers 203, i.e., midway along the storage guide 204. The staplers 206 staple the center of a sheet bundle in cooperation with an anvil 207 so located as to face the staplers 206.

A pair of folding rollers 208 are arranged downstream from the staplers 206, and a push member 209 is disposed at a position where the push member 209 faces the pair of folding rollers 208. The push member 209 is moved toward a sheet bundle stored in the storage guide 204. Then, the sheet bundle is pushed between the pair of folding rollers 208, and folded by the pair of folding rollers 208. The sheet bundle is discharged to a discharge tray 211 via discharge rollers 210.

To fold a sheet bundle stapled by the staplers 206, the positioning member 205 is adjusted to the sheet size so as to set the stapled position of the sheet bundle at the central position (nip position) of the pair of folding rollers 208 after the end of stapling processing. The sheet bundle can be folded at the stapled position as the center.

Similar to the section 400, the folding processing section 500 comprises an auxiliary convey path 212 which communicates with the entrance rollers 201 and a pair of auxiliary convey rollers 213 in order to receive a sheet from the inserter 900 (to be described later) and fold it in two or to feed the sheet to the finisher 600 without folding it in two.

An entrance sensor 214 for detecting entrance of a sheet is attached to the entrance of the folding processing section 500. A sheet size detecting sensor 215 for detecting the size of a passing sheet is disposed downstream of the convey rollers 203. A discharge sensor 216 for detecting discharge of a sheet bundle is attached near the exit.

Control of the folding processing section 500 including control of these sensors is performed by the folding control portion 217 shown in FIG. 3.

### Inserter 900

In FIG. 3, the inserter 900 is used to supply, e.g., a cover sheet without the mediacy of the image forming unit 300.

A sheet bundle stacked on a tray 901 is conveyed by a sheet feeding roller 902 to a separation portion made up of a convey roller 903 and separation belt 904. The sheets of the bundle are separated one by one from the uppermost sheet by the convey roller 903 and separation belt 904. Each separated sheet is conveyed to the auxiliary convey path 212 of the folding processing section 500 via a pair of extraction rollers 905 near the separation portion.

A sheet set sensor 910 for detecting whether a sheet is set is interposed between the sheet feeding roller 902 and the convey roller 903.

The inserter 900 can be arranged not only in the folding processing section 500 but also in the section 400 so as to supply a sheet to an auxiliary convey path 467 of the section 400.

The inserter 900 is controlled by the inserter control portion 911 shown in FIG. 3.

### Finisher 600

In FIG. 3, the finisher 600 executes processing of receiving a sheet conveyed from the image forming unit 300 via the folding processing section 500 and aligning a plurality of received sheets into one sheet bundle, stapling processing of stapling the trailing end portion of the sheet bundle, sorting processing, non-sorting processing, and sheet post-processing such as bookbinding processing.

As shown in FIG. 3, the finisher 600 has a finisher path 504 along which a pair of entrance rollers 502 and a pair of convey rollers 503 for receiving a sheet conveyed from the image forming unit 300 via the folding processing section 500 into the finisher 600 are arranged. An entrance sensor 531 is interposed between the pair of entrance rollers 502 and the pair of convey rollers 503.

A sheet guided to the finisher path 504 is conveyed toward a buffer roller 505 via the pair of convey rollers 503. The pair of convey rollers 503 and the buffer roller 505 can rotate clockwise and counterclockwise.

A punch unit 508 is interposed between the pair of convey rollers 503 and the buffer roller 505. The punch unit 508 is operated as needed, and performs punching processing near the trailing end of a sheet conveyed via the pair of convey rollers 503. A punch unit sensor 555 is interposed between the pair of convey rollers 503 and the punch unit 508.

The buffer roller 505 allows winding a predetermined number of sheets conveyed via the pair of convey rollers 503 around the buffer roller 505. A sheet is wound by press rollers 512, 513, and 514 during rotation of the roller 505. The sheet wound around the buffer roller 505 is conveyed in the rotational direction of the buffer roller 505.

A switching flapper 510 is interposed between the press rollers 513 and 514, and a switching flapper 511 is disposed downward from the press roller 514.

The switching flapper 510 separates a sheet wound around the buffer roller 505 from the buffer roller 505 and guides the sheet to a non-sorting path 521 or sorting path 522.

The sheet guided to the non-sorting path 521 by the switching flapper 510 is discharged onto the sample tray 701 via the pair of discharge rollers 509. A discharge sensor 533 for detecting a jam is arranged midway along the non-sorting path 521.

The switching flapper 511 separates a sheet wound around the buffer roller 505 from the buffer roller 505 and guides the sheet to the sorting path 522. Further, the switching flapper 511 guides a sheet kept wound around the buffer roller 505 to the buffer roller 505.

The sheet guided to the sorting path 522 by the switching flapper 510 is stacked on an intermediate tray 630 via pairs of convey rollers 506 and 507. A sheet bundle stacked on the intermediate tray 630 undergoes alignment processing or stapling processing in accordance with settings from the operating portion 303 (see FIG. 2). Then, the sheet bundle is discharged onto the stack tray 700 via discharge rollers 680a and 680b.

Stapling processing is executed by a stapler 601. The sample tray 701 and stack tray 700 can automatically travel in the vertical direction.

When the sheet bundle is discharged from the intermediate tray 630 to the stack tray 700, a processing tray 631 (see FIGS. 1 and 3) projects outside the copying machine 1000 so as to reliably stack the sheet bundle on the stack tray 700.

### Section 400 for Processing of Folding in Three

The section 400 for processing of folding in three or Z shape as the main part of the embodiment according to the present invention will be described in detail. As shown in FIG. 1, a sheet discharged from the image forming unit 300 via the pair of discharge rollers 118 is fed to a three-folding convey path 450 in the section 400. The section 400 performs three-folding processing so as to fold the sheet in three.

When the operating portion 303 (see FIG. 2) designates an A3- or B4-size sheet and three-folding processing, the sheet discharged from the image forming unit 300 is folded in three.

In another case, the sheet discharged from the image forming unit 300 is conveyed to the folding processing section 500 without performing folding processing for the sheet, or directly conveyed to the finisher 600 through the folding processing section.

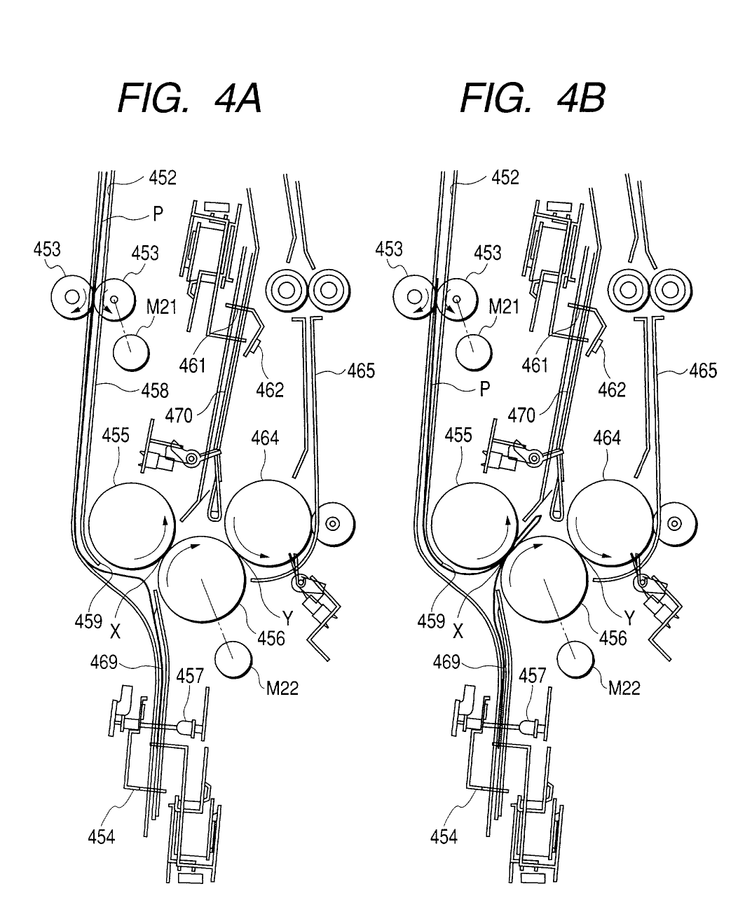

The section 400 guides a sheet to be folded in three to an acceptance convey path 452 shown in FIG. 4A by a flapper 451. The sheet is conveyed to a first folding path 469 via a pair of convey rollers 453, and stopped by a tip end of sheet receiving stopper 454 inserted in the first folding path 469.

At this time, if a sheet P strongly hits the tip end of sheet receiving stopper 454 and vibrates within the first folding path 469, or jumps on the tip end of sheet receiving stopper 454 and skews, the sheet P cannot be folded in parallel to the tip end of the sheet P in folding the sheet P by first and second folding rollers 455 and 456. The ends of the sheet P cannot be aligned to each other, and one end protrudes from the other end to obstruct the conveyance of the sheet P and cause a jam.

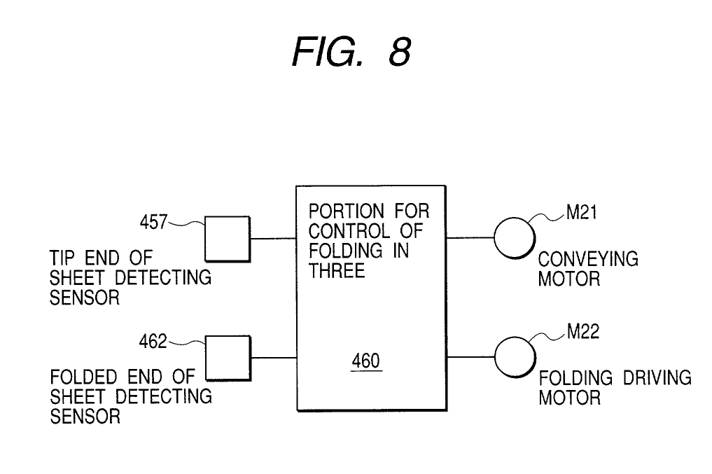

To prevent the conveyed sheet P from jumping on the tip end of sheet receiving stopper 454, a tip end of sheet detecting sensor 457 detects that the tip end of the sheet P slightly reaches the upstream of the tip end of sheet receiving stopper 454. Then, the portion 460 (see FIG. 8) stops for the first time a conveying motor M21 which rotates the convey rollers 453. After the lapse of a predetermined time, the portion 460 starts (first start) the conveying motor M21 to bring the tip end of the sheet P into contact with the tip end of sheet receiving stopper 454.

The sheet P gently lands on the tip end of sheet receiving stopper 454 within the first folding path 469 without jumping on the tip end of sheet receiving stopper 454.

The pair of convey rollers 453 continue conveying the sheet P while the tip end of the sheet P is kept in contact with the tip end of sheet receiving stopper 454 by the conveying motor M21. The sheet P protrudes from an opening 459 of a guide wall 458, and comes in the buckled state close to a nip portion X formed by the first and second folding rollers 455 and 456.

When the sheet P comes close to the nip portion X, the portion 460 (see FIG. 2) stops the conveying motor M21 for the second time. After vibrations at the looped portion of the sheet P are settled, the portion 460 starts the conveying motor M21 for the second time. As a result, the looped portion of the sheet P is stably fed to the nip portion X.

The second stop timing of the conveying motor M21 is determined based on the rotational speed after the tip end of sheet detecting sensor 457 detects the tip end of the sheet P before the tip end comes into contact with the tip end of sheet receiving stopper 454 and the conveying motor M21 starts for the first time.

In this embodiment, the conveying motor M21 is temporarily stopped (first and second stop operations) when the sheet P comes close to the tip end of sheet receiving stopper 454 and when the sheet P comes close to the nip portion X. Alternatively, the conveying motor M21 may be kept rotated at a low speed.

The sheet P is accurately folded in two because the sheet P is reduced in speed or temporarily stopped immediately before the sheet P comes into contact with the tip end of sheet receiving stopper 454 and immediately before the sheet P is fed into the nip portion X between the first and second folding rollers 455 and 456.

After that, as shown in FIG. 4B, the sheet P is folded in two by the first and second folding rollers 455 and 456 and conveyed to a second folding path 470.

In the second folding path 470, the folded end of the conveyed sheet P is detected by a folded end of sheet detecting sensor 462 immediately before the sheet P comes into contact with a folded end of sheet receiving stopper 461 in the second folding path 470. The portion 460 (see FIG. 8) stops for the third time a folding driving motor M22 which drives the second folding roller 456.

Accordingly, the folded end of the sheet P gently comes into contact with the folded end of sheet receiving stopper 461 by inertial rotation of the folding roller 456 and a folding roller 464 without skewing or jumping on the folded end of sheet receiving stopper 461.

The folding driving motor M22 rotates the three folding rollers 455, 456, and 464.

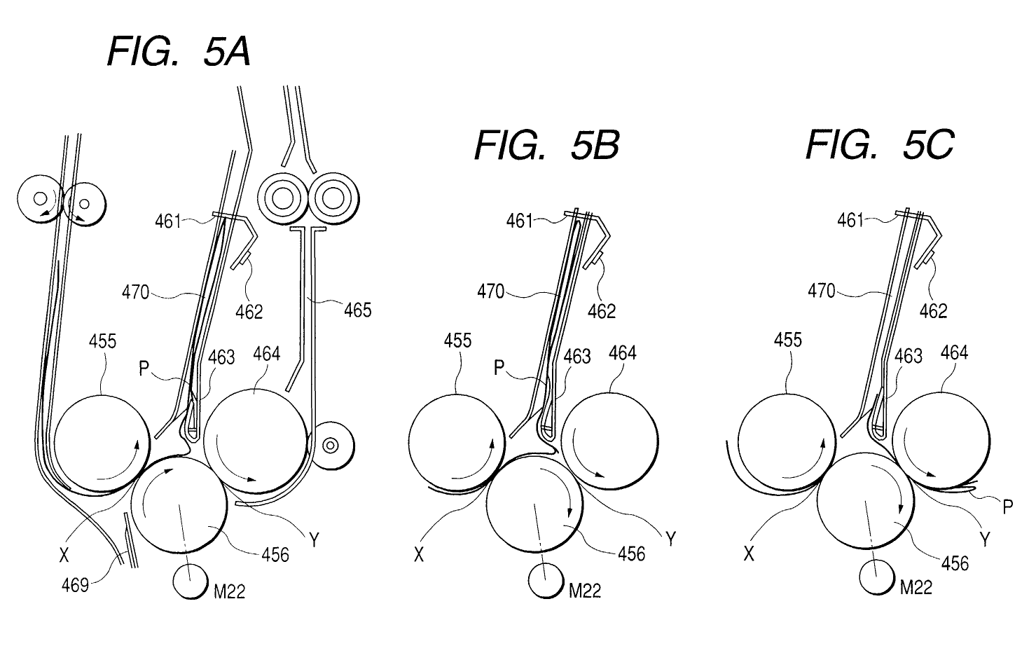

After the folded end of the sheet P comes into contact with the folded end of sheet receiving stopper 461, as shown in FIG. 5A, the portion 460 starts the folding driving motor M22 for the third time. This third start is done a predetermined time after the folded end of sheet detecting sensor 462 detects the folded end of the sheet P.

In this embodiment, the conveying motor M22 is stopped for the third time when the sheet P comes close to the folded end of sheet receiving stopper 461. Alternatively, the conveying motor M22 may be kept rotated at a low speed.

Thereafter, as shown in FIG. 5B, a portion of the sheet P that faces the lower end of a folding guide 463 starts buckling. This portion is formed into a loop shape, and comes close to a nip portion Y between the second and third folding rollers 456 and 464 together with the portion already folded in two.

In the section 400 of this embodiment, the first and third folding rollers 455 and 464 use the common second folding roller 456 as a roller pair.

That is, the first and second folding rollers 455 and 456 are paired, and the third and second folding rollers 464 and 456 are also paired.

When the looped portion of the sheet P almost comes close to the nip portion Y between the second and third folding rollers 456 and 464, the portion 460 stops the folding driving motor M22 for the fourth time. This cancels vibrations at the looped portion.

The fourth rotation stop of the folding driving motor M22 is performed a predetermined time after the folding driving motor M22 starts for the third time.

The folding driving motor M22 starts for the fourth time a predetermined time after it stops rotation for the fourth time for a predetermined time, and causes the looped portion of the sheet P to enter the second and third folding rollers 456 and 464. FIG. 5C shows this state.

As a result, the sheet P is accurately folded in three without any wrinkle, and discharged from the second and third folding rollers 456 and 464.

The sheet P is fed to the folding processing section 500 by a pair of discharge rollers 466 shown in FIG. 1 via a feeding convey path 465 shown in FIGS. 1, 4A, and 4B.

The following operation is automatically performed by the portion 460 shown in FIG. 2.

In this embodiment, the folding driving motor M22 stops and starts four times each in the operation of the section 400. However, a sheet can also be accurately folded by only the fourth stop and start operations.

The folded end of sheet detecting sensor 462 is not always required, and folding of the sheet P can be controlled by only the tip end of sheet detecting sensor 457.

More specifically, the folding driving motor M22 stops for the third and fourth times when the tip end of sheet detecting sensor 457 detects the trailing end (which was a tip end before) of the sheet P in moving apart from the tip end of sheet receiving stopper 454 after the sheet P comes into contact with the tip end of sheet receiving stopper 454.

The section 400 comprises the auxiliary convey path 467 which communicates with the acceptance convey path 452, and a pair of auxiliary convey rollers 468 in order to receive the sheet P from the inserter 900 and fold it in three, as shown in FIG. 1.

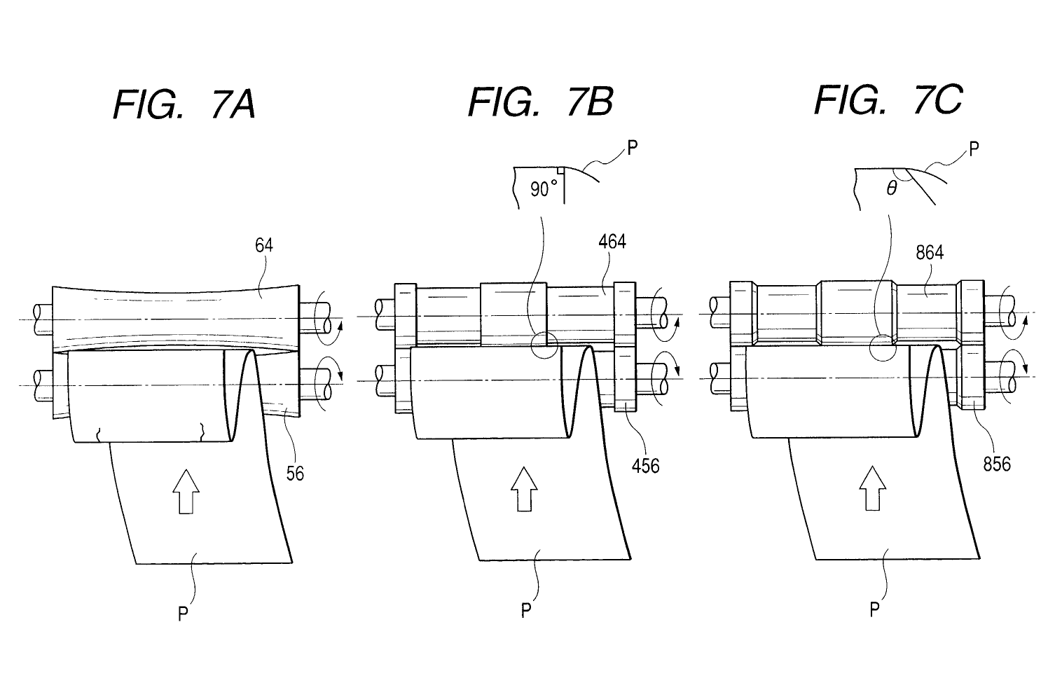

In the prior art, the sheet P contacts the rollers 56 and 64 across the whole area. When the sheet P is nipped and conveyed while its tip end and looped folded portion are simultaneously pulled in the widthwise direction at the two ends of each of the rollers, the pressure from the two ends of the sheet P toward the sheet center cannot be relieved, generating a crease at a position as shown in FIG. 7A.

To prevent this, the contact area of the sheet P on the rollers 455, 456, and 464 is reduced when the sheet P is nipped and conveyed at the nip portions X and Y by the first, second, and third folding rollers 455, 456, and 464 in the section 400 of the embodiment. A relief for the pressure applied in folding a sheet can be ensured at the non-contact portions between the sheet P and the folding rollers 455, 456, and 464, and any crease can be prevented.

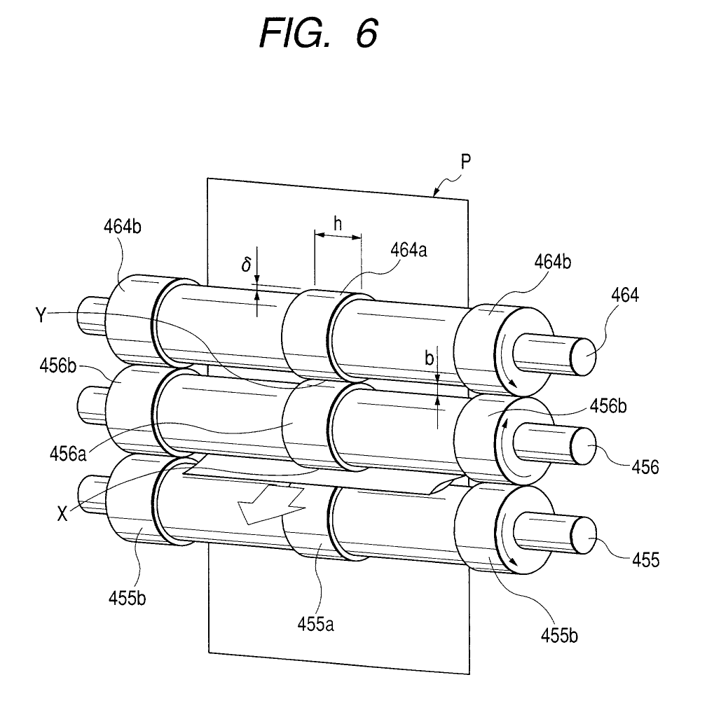

For this purpose, the first, second, and third folding rollers 455, 456, and 464 have large-diameter portions along the roller shaft, as shown in FIG. 6. Each roller has three regions with a large roller diameter (large-diameter portions): a large-diameter portion 455a, 456a, or 464a at the sheet convey center portion, and large-diameter portions 455b, 456b, or 464b at two sheet convey ends outside the maximum size of a three-foldable sheet P.

With this structure, the sheet P contacts the respective folding rollers at the large-diameter portions 455a, 456a, and 464a at the sheet convey center portion when the sheet P is nipped at the nip portions X and Y.

As a result, the contact area between the sheet P and the first, second, and third folding rollers 455, 456, and 464 can be reduced. A relief for the sheet folding pressure from the two ends of the roller shaft can be secured at a portion where the sheet P creases, and any crease can be prevented.

The large-diameter portions 455b, 456b, and 464b (regions with a large roller diameter at two ends) outside the maximum convey size of the sheet P are formed at positions where the sheet P does not contact the large-diameter portions 455b, 456b, and 464b in consideration of inclined feeding or skew feeding of the sheet P.

If the sheet P contacts the large-diameter portions 455b, 456b, and 464b, the sheet P creases due to inclined feeding or skew feeding.

Letting α be thee width of the movable range of the maximum convey size along the roller shaft in the sheet P nipped and conveyed at the nip portions X and Y, and β be the layout distances between the large-diameter portions 455b, between the large-diameter portions 456b, and between the large-diameter portions 464b, α<β holds.

With α<β, the sheet P does not contact the large-diameter portions 455b, 456b, and 464b, and a crease by the above-mentioned cause does not occur.

With α<β, the sheet P is guided by the large-diameter portions 455b, 456b, and 464b without any convey error caused by a lateral registration shift or the like.

If the widths of the large-diameter portions 455a, 456a, and 464a along the shaft at the sheet convey center portion are much smaller than the width of the sheet P, the fold becomes loose. The folded sheet becomes bulky and is unstably stacked on the sheet tray.

Thus, a width h of the large-diameter portions 455a, 456a, and 464a (regions with a large roller diameter at the sheet convey center portion) along the shaft is set about ½ the minimum (e.g., B4) size width (width s) of a three-foldable sheet size. In other words, h ∝½s is set as the width of the large-diameter portions 455a, 456a, and 464a along the shaft for stabling folding the sheet and nipping and conveying the sheet P.

The large-diameter portions 455a, 456a, 464a, 455b, 456b, and 464b are so formed as to satisfy δ<3t when the step along the shaft on the first, second, and third folding rollers 455, 456, and 464 is set as δ, and the sheet thickness is set as t.

With the steps δ of the large-diameter portions 455a, 456a, and 464a, a gap for ensuring a relief for the sheet folding pressure can be formed at a portion where the sheet P creases.

With the steps δ of the large-diameter portions 455b, 456b, and 464b, the steps at the two ends serve as a guide for the sheet P in conveying the sheet P at the nip portions X and Y, and stable conveyance can be attained without any lateral registration shift. In addition, the sheet P does not contact the large-diameter portions 455b, 456b, and 464b and is not diagonally conveyed, so that a crease by inclined feeding of the sheet P can be prevented.

Gaps b between the stepped folding rollers 455, 456, and 464 are reduced by the pressure when the folding rollers 455, 456, and 464 abut against each other. Letting b be the gap between the rollers, the gap b and the step δ of the folding roller (large-diameter portion) satisfy b<2δ.

Letting t be the thickness of the sheet P, the folding rollers 455, 456, and 464 abut against each other such that the gap b between the rollers satisfies b<3t. The folding rollers 455, 456, and 464 are so set as to satisfy b<3t even in the initial state or when no nip is formed due to high rubber hardness.

This structure enables tightly, stably nipping and conveying the sheet P at the sheet convey center portion of the roller without reducing the folding pressure between a pair of folding rollers or loosening the fold. At the same time, the gap b between the rollers can secure a relief for the pressure on the sheet with respect to the sheet folding pressure from two sheet ends when the sheet P is tightly nipped at the nip portions X and Y. This is effective for preventing any crease.

More specifically, when the thickness t of the sheet P is about 0.1 mm, the step δ along the roller shaft is set to 0.2 mm, and the gap b between the rollers is set to 0.3 (for three sheets because of folding in three) mm or less upon nip formation by abutment between a pair of rollers.

The above rollers can reduce the contact area of the sheet P on the rollers in folding the sheet P, and can prevent any crease.

In this embodiment, large-diameter portions are formed on a pair of rollers made up of the first and second folding rollers 455 and 456 and a pair of rollers made up of the second and third folding rollers 456 and 464. Alternatively, only one of the roller pairs may be stepped.

That is, at least either the pair of rollers made up of the first and second folding rollers 455 and 456 or the pair of rollers made up of the second and third folding rollers 456 and 464 may be stepped.

The structure of the present invention may be applied to the pair of folding rollers 208 in the folding processing section 500 as shown in FIG. 3.

FIG. 7C is a view showing another structure of the section for processing of folding in three according to the embodiment shown in FIG. 7B. In FIG. 7C, large-diameter portions 856a and 864a (regions with a large roller diameter) are formed at the sheet convey center portions of second and third folding rollers 856 and 864. Large-diameter portions 856b and 864b (regions with a large roller diameter) are formed at the two sheet convey ends of a corresponding one of the folding rollers 856 and 864.

The second and third folding rollers 856 and 864 are tapered toward the two ends of each of the large-diameter portions 856a, 864a, 856b, and 864b of the stepped rollers.

From the comparison between FIGS. 7B and 7C, an angle θ defined by the end of the large-diameter portion and the sheet P in FIG. 7C is θ>90°, which is larger than angle of 90° defined by the end of the large-diameter portion and the sheet P in FIG. 7B.

Since the large-diameter portion is tapered, the angles at the ends of the large-diameter portions 856a, 864a, 856b, and 864b are larger than those at the ends of the large-diameter portions 456a, 464a, 456b, and 464b.

If the large-diameter portion adopts a tapered structure, the ends of the large-diameter portions 856a, 864a, 856b, and 864b gently contact the sheet P when the sheet P enters the nip portion for folding processing. This can reduce a crease at the large-diameter portion in folding the sheet P.

The above embodiment has exemplified a copying machine. However, the present invention is not limited to the copying machine and can be applied to another image forming apparatus such as a laser printer.

The image forming means may be of the ink-jet type, thermal transfer recording type, or thermal recording type other than the electrophotographic type.

What is claimed is:

1. A sheet folding apparatus for folding the sheet by nipping and conveying a sheet by a pair of folding rollers and, wherein at least one of the pair of folding rollers has large-diameter portion and small-diameter portion along an axis thereof.

2. A sheet folding apparatus according to claim 1, wherein a large-diameter portion for nipping and conveying the sheet is provided at a sheet convey center portion of the roller.

3. A sheet folding apparatus according to claim 2, wherein the large-diameter portion is provided at the sheet convey center portion such that a width of the large-diameter portion in the axis direction, which is provided at the sheet convey center portion of the folding roller is substantially ½ of a minimum width of a sheet size foldable in the sheet folding apparatus.

4. A sheet folding apparatus according to claim 3, wherein the large-diameter portion of the roller is positioned outside a movable range of a maximum-size sheet in the apparatus.

5. A sheet folding apparatus according to claim 1, wherein a predetermined gap is formed between the rollers at a convey nip between the pair of folding rollers.

6. A sheet folding apparatus according to claim 4, wherein a predetermined gap is formed between the rollers at a convey nip between the pair of folding rollers.

7. A sheet folding apparatus according to claim 5, wherein the predetermined gap between the rollers is set smaller than a thickness of three sheets conveyed to the nip.

8. A sheet folding apparatus according to claim 6, wherein the predetermined gap between the rollers is set smaller than a thickness of three sheets conveyed to the nip.

9. A sheet folding apparatus according to claim 1, wherein the large-diameter portion of the roller is tapered.

10. A sheet folding apparatus according to claim 8, wherein the large-diameter portion of the roller includes a taper.

11. An image forming apparatus having image forming means for forming an image on a sheet, sheet conveying means for conveying the sheet on which the image is formed by said image forming means, and sheet folding processing means for folding the conveyed sheet, including a sheet folding apparatus according to any one of claims 1 to 10 as said sheet folding processing means.
